(19) United States
(12) Patent Application Publication
(10) Pub. No.: US 2004/0215823 A1
(43) Pub. Date: Oct. 28, 2004

(54) System and method for reducing DNS lookup traffic in a computer data network

(76) Inventors: Kevin P. Kleinfelter, Atlanta, GA (US); Kim Littrell, Marietta, GA (US)

Correspondence Address: BAMBI FAIVRE WALTERS, PO BOX 5743, WILLIAMSBURG, VA, 23188, US

(21) Appl. No.: 10/183,624

(22) Filed: Jun. 28, 2002

(51) Int. Cl. G06F 15/16

(52) U.S. Cl. 709/245

(57) ABSTRACT

A system for reducing Domain Name System (DNS) lookup traffic in a computer data network includes a router and a cache database associated with the router. The cache database includes at least one hostname and an IP address corresponding to the hostname. The router receives a request for name resolution including a hostname from a client computer. The router compares the hostname with the information in the cache database. If the cache database includes an entry corresponding to the hostname, the router responds to the request by providing an IP address corresponding to the hostname to the client computer. Otherwise, the router forwards the request to a DNS server and receives a response including the IP address corresponding to the hostname from the DNS server. Upon receiving the IP address corresponding to the hostname, the router stores the information in the cache database and sends the IP address to the client computer.

### BACKGROUND

1. Field of the Invention

The present invention relates generally to the field of computer data networks, and more particularly to the reduction of Domain Name System (DNS) lookup traffic in a computer data network.

2. Background of the Invention

As known in the art, computers connected to the Internet use the well-known transmission control protocol/internet protocol (TCP/IP) to negotiate the network communications with other computers on the network. TCP/IP network packets are transmitted to other computers using an IP address to identify the source and destination computers. An IP address is currently defined as a 32-bit numbers which is generally expressed as four octets (converted to their decimal values) separated by a period, for example, 12.34.56.78. Due to the very large number of computers connected to the Internet, it would not be convenient for the users to memorize the IP address assigned to each of the computers being accessed. Accordingly, a Domain Name System (DNS) was implemented whereby a computer may be identified by a mnemonic hostname, such as www.whitehouse.gov.

DNS is a name resolution method that allows the users and applications to initiate network communications with a hostname, without an IP address, for other computers on the network. The DNS server maintains a database of hostnames and their corresponding IP addresses. The users can open a web page on his or her web browser by directing the application to connect to a particular universal resource location (URL) which identifies the web server and the particular document to be downloaded to the browser. When the sending computer or application needs to open a network connection to another computer, it first contacts a DNS server to resolve the other computer's hostname to its IP address. DNS servers are distributed throughout the Internet. DNS servers communicate with other DNS servers to resolve a network address.

The standard convention for a URL is ‘protocol://hostname/name of file.’ The protocol includes, for example, FTP (file transfer protocol), telnet and HTTP (hypertext transfer protocol). Typically, HTTP is used to transfer information (also referred to as “content”) from a web server application for display by web browser (a web client computer application). HTTP is the set of rules for exchanging files, for example, text, graphic images, sound, and video, in the Internet. Content is generally organized into groups of data, referred to as a “web page,” defined in documents downloaded from the web server to the browser. The web page is a text file that contains text and a set of HTML (hyper text markup language) tags that describe how the text should be formatted when a browser displays the web page for the user.

A HTML tag is a code element that tells the web browser what to do with the text. Each tag appear as letters or words between a ‘<’ and a ‘>.’ For example, <HTML> tells the browser that this is the beginning of an HTML document and <TITLE> tells the browser that this is the title of the page. HTML defines a document format, for example, the page layout, fonts and image elements (graphic elements). Each of the tags defining an image element includes the location of the image element, for example, <img src=“URL”> or <img src=“name of the file”>. The HTML document also has ability to link text and/or an image to another document or section of a document. Each link contains the URL of a web page residing on the same server or any server in the internet, for example, <a href=“URL”>. The web browser interprets the set of HTML tags within the HTML document and displays for the user.

FIG. 1 is a schematic diagram of web page 100 as it may be displayed on a client computer. Web page 100 may include a plurality of textual information, represented by text displays 102 and 104 in FIG. 1. Web page 100 may also include image elements 106, 108, 110 and 112. These image elements are displayed on the web page via instructions to download image elements from a URL in an HTML document. For example, URL 116 is associated with image element 106 as shown in FIG. 1. Similarly, URLs 118, 120 and 122 are associated with image elements 108, 110 and 112, respectively. Each image element is independently downloaded. The URLs are shown in FIG. 1 with a dashed outline to indicate that the actual URL is not typically displayed on the web browser, while the image elements specified by the URLs are displayed.

FIG. 2 is a schematic diagram showing a basic architecture used to provide web-based services. This architecture includes client computer 200 and server 202. Client computer 200 can include a processor 204 coupled via bus 206 to network port 208, and memory 210. Client computer 200 can communicate with server 202 via network 212. Server 202 can include a processor 214 coupled via bus 216 to network port 218, and memory 220. One or more routers may be used within network 212 to direct network packets to their destination. Router 222 is one such router. The function and operation of conventional IP routers are well-known in the art. For example, router 222 receives network packets from client computer 200. For each of the network packets, the router determines the best available route, using one or more routing tables, and sends the packets to their destination via the best available route.

FIG. 3 is a flow diagram showing steps used in conventional web-based systems to download a web page. In step 300, the web browser receives a user's request to open a particular URL. In step 302, the web browser sends the user's request to a DNS server for name resolution for the web server's hostname identified in the URL. The router forwards the request to the DNS server. In step 304, the DNS server responds to the request and the web browser receives the IP address assigned to the web server. In step 306, the web browser opens a network connection with the IP address supplied by the DNS server and sends an HTTP request to the web server, asking for the file. In step 308, the web server responds to the request and the web browser receives an HTML document for the web page from the web server. Once the HTML document has been downloaded, the web browser closes the network connection in step 310

Next, in step 312, the web browser examines the HTML document and determines whether or not there are additional image elements to be downloaded for display within the web page. If there are no additional image elements to be downloaded for display, the process ends. Otherwise, in step 314, the web browser requests name resolution for the web server's hostname indicated in the URL associated with the image element. This URL is indicated within the HTML document downloaded in step 308. The DNS server responds to the DNS lookup request by providing the IP address corresponding to the web server's hostname. In step 316, the web browser receives the IP address assigned to the web server. In step 318, the web browser opens a network connection using the IP address supplied by the DNS server. In step 320, the web browser downloads the image element specified in the user's URL request. Once the image element has been downloaded, the web browser closes the network connection in step 322. The process repeats steps 312-322 until all image elements identified in the HTML document have been downloaded.

As can be seen from the steps shown in FIG. 3, the web browser may make numerous DNS lookup requests each time a single web page is downloaded, even though the web page typically references image elements that are stored on the same web server host as the web page. The repeated DNS lookup operations generally requests name resolution for the same host in numerous succession just to render a single web page. If an HTML document (web document) for a web page includes, for example, ten different image elements, the web browser will perform a total of eleven DNS lookup operations (one to download the HTML document and one operation for each image element), even if the DNS lookup operations are requesting name resolution for the same host. As web content developers continue to increase the complexity of web pages, the number of image elements within a particular web document may become very large. Accordingly, the load on DNS servers has increased. The load on DNS server 224 is furthermore increased due to the multiple requests for the same information. Not only can the DNS server itself be impaired due to the increased load, but the network traffic across network 212 is increased with each DNS lookup request resulting in poorer performance across the network.

A need therefore exists for systems and methods of reducing requests for name resolution for web-based services.

### SUMMARY OF THE INVENTION

The present invention is related to a system and method for reducing DNS lookup traffic in a computer data network.

In an embodiment of the present invention, a system for reducing DNS lookup traffic in a computer data network includes a router and a cache database associated with the router. The cache database includes at least one hostname and an IP address corresponding to the hostname. The router receives a request for name resolution including a hostname from a client computer. The router compares the hostname with the information in the cache database. If the cache database includes an entry corresponding to the hostname, the router responds to the request by providing an IP address corresponding to the hostname to the client computer. Otherwise, the router forwards the request to a DNS server and receives a response including the IP address corresponding to the hostname from the DNS server. Upon receiving the IP address corresponding to the hostname, the router stores the information in the cache database and sends the IP address to the client computer.

In another embodiment of the present invention, a method for reducing DNS lookup traffic in a computer data network, in a system including a router and a cache database associated with the router, includes the steps of receiving a query including a first hostname from a client computer and comparing the first hostname with information corresponding to the cache database including at least one hostname and an IP address corresponding to the hostname received from a DNS server. If the cache database includes an entry corresponding to the first hostname, the method further includes the step of responding to the query by sending an IP address corresponding to the first hostname to the client computer. Otherwise, the method includes the steps of forwarding the query to a DNS server, receiving a response including an IP address corresponding to the first hostname from the DNS server, caching the information in the cache database, and sending the IP address to the client computer.

Embodiments of the present invention relate to data communications via one or more networks. The data communications can be carried by one or more communications channels of the one or more networks. A network can include wired communication links (e.g., coaxial cable, copper wires, optical fibers, a combination thereof, and so on), wireless communication links (e.g., satellite communication links, terrestrial wireless communication links, satellite-to-terrestrial communication links, a combination thereof, and so on), or a combination thereof A communications link can include one or more communications channels, where a communications channel carries communications. For example, a communications link can include multiplexed communications channels, such as time division multiplexing (TDM) channels, frequency division multiplexing (FDM) channels, code division multiplexing (CDM) channels, wave division multiplexing (WDM) channels, a combination thereof, and so on.

### BRIEF DESCRIPTION OF THE DRAWINGS

FIG. 1 is a schematic diagram showing a typical web page.

FIG. 2 is a schematic diagram showing a typical architecture used to provide web-based services.

FIG. 3 is a flow diagram showing steps used in conventional web-based systems to download a web document.

FIG. 4 is a schematic diagram showing a system according to a preferred embodiment of the present invention.

FIG. 5 is a flow diagram showing the steps that may be performed to reduce DNS lookup traffic in a computer data network according to a preferred embodiment of the present invention.

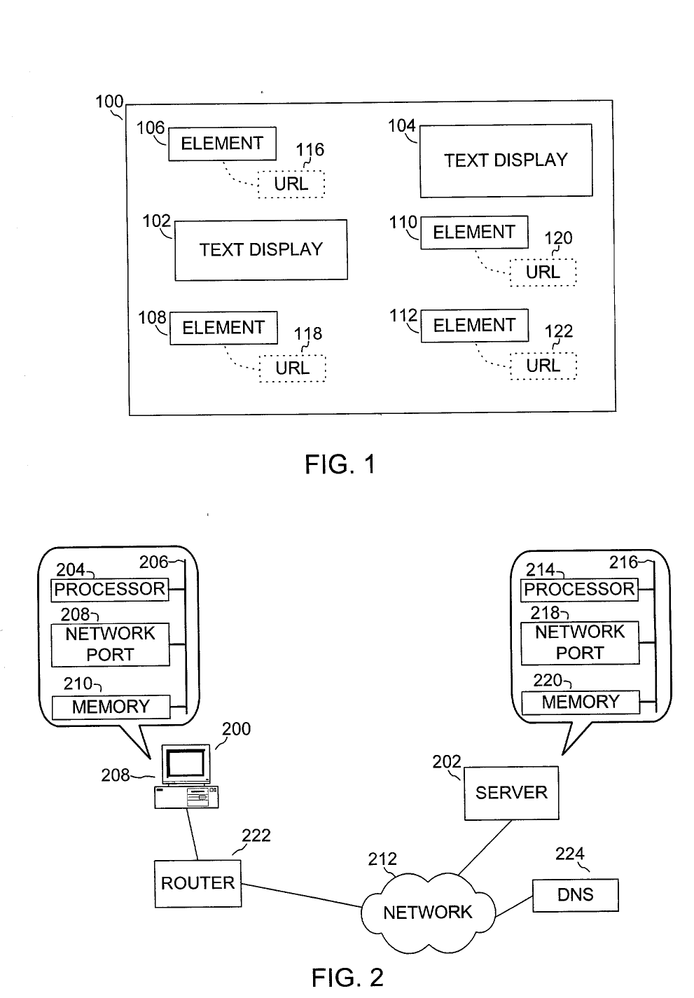

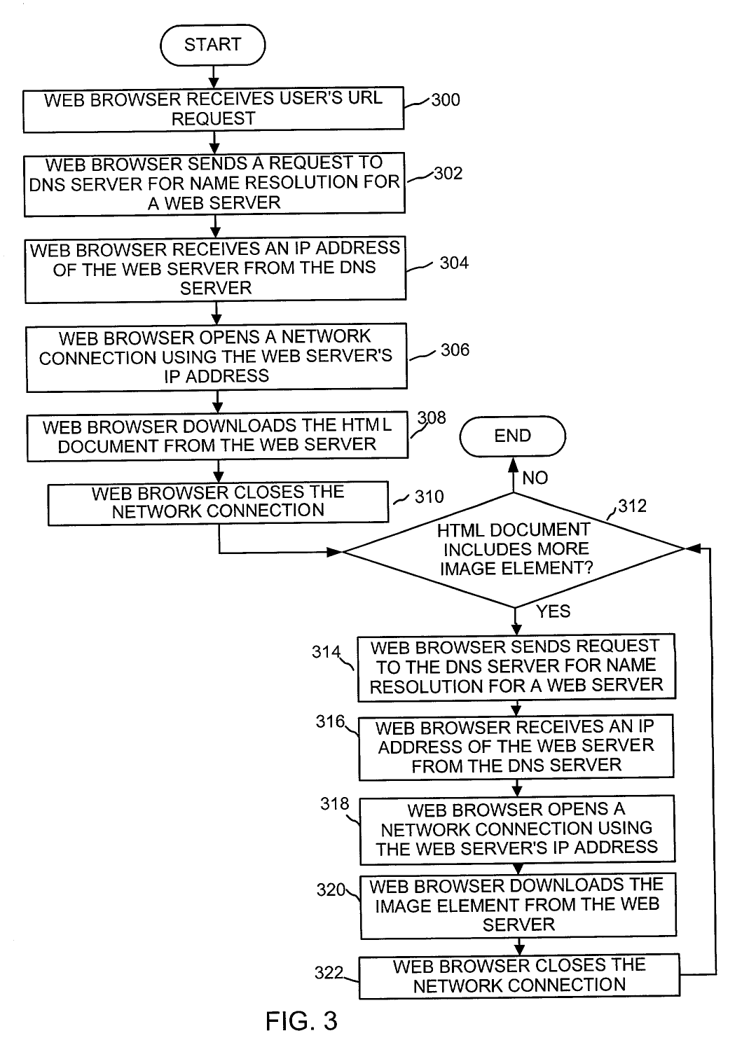

### DETAILED DESCRIPTION OF THE INVENTION

The present invention solves the above-identified problem by implementing a DNS caching system on one or more routers in the network. Reference will now be made in detail to the preferred embodiments of the present invention, examples of which are illustrated in the accompanying drawings.

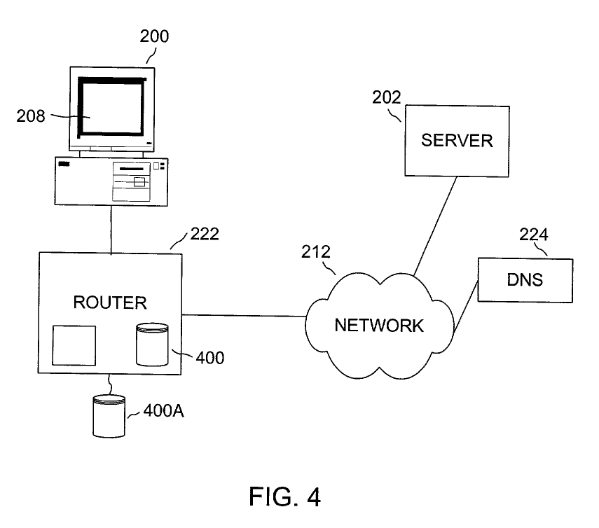

FIG. 4 is a schematic diagram of a system for reducing DNS lookup traffic in a network according to a preferred embodiment of the present invention. The system includes a router 222 associated with a cache database 400. As shown in FIG. 4, cache database 400 can be internal and/or external (400A) to the router.

Preferably, cache database 400 is internal to the router. Cache database 400 includes the information received from a DNS server including the hostnames and their corresponding IP addresses. As described above, routers are used in networks to direct network packets to their destination. Accordingly, network packets from client computer 200 would likely be processed by router 222.

According to the present invention, when router 222 receives a network packet from client computer 200, the router examines the contents of the message to determine whether or not it is a DNS lookup request. Router 222 may make this determination, for example, by checking the TCP port indicated in the network packet. If the network packet is a DNS lookup request, the router checks cache database 400 to see if the router has the information needed to respond to the request. If cache database 400 includes an entry for the hostname to be resolved, router 222 send an IP address corresponding to the hostname to the client computer.

If cache database 400 does not include an IP address corresponding to the hostname, router 222 sends the request on to a DNS server 224. DNS server 224 responds to the request and sends the IP address corresponding to the hostname to the router. Upon receiving the IP address corresponding to the hostname from the DNS server 224, router 222 stores the information in the cache database 400 and passes the IP address to the client computer.

Preferably, cache database 400 is relatively small so that router 222 does not need to spend too much time searching the cache database. The entries in cache database 400 are retained unless the cache database is full. However, the entries in cache database 400 do not need to be retained for a long duration. In one embodiment, each of the entries in cache database 400 may be retained, for example, for about 30 seconds to 2 minutes, preferably for about 30 seconds to 1 minute. For example, the entry stored for 1 minute can satisfy many requests since a web page typically references many image elements that are stored on a common web server and a web browser requests name resolution for the same host in succession to render a single web page. Each of the entries in cache database 400 can include a time stamp. For example, the time stamp can indicate when the entry is last requested or resolved. In another embodiment, the time stamp can be used to manage the cache database 400. When the cache database is full, the oldest data entry, according to the time stamp, can be deleted.

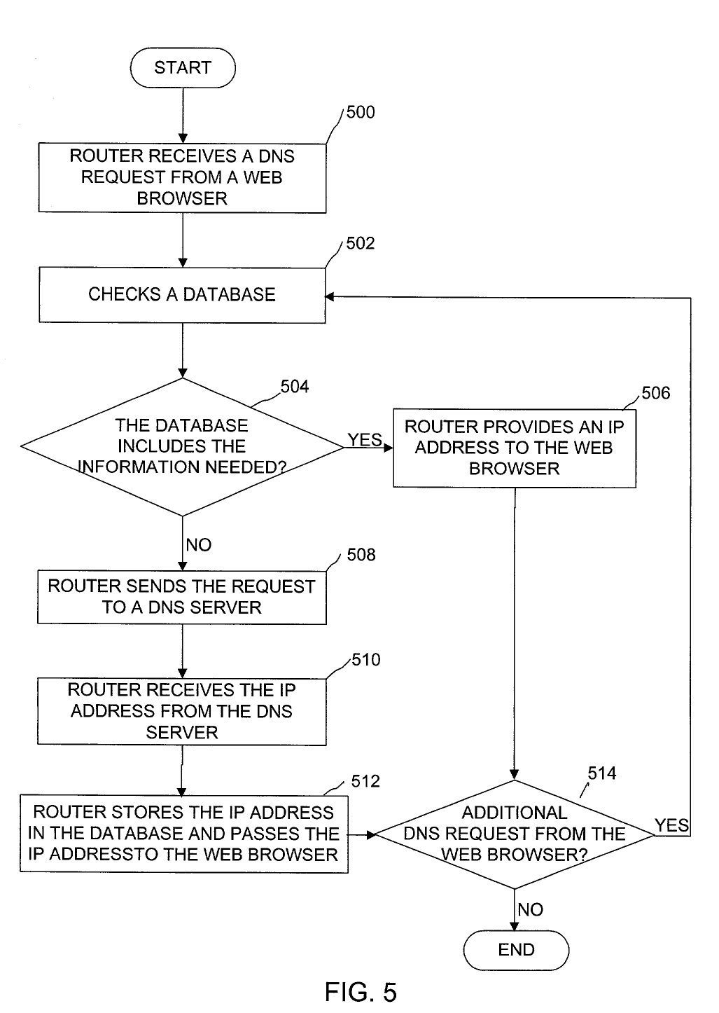

FIG. 5 is a flow diagram showing the steps that may be used for reducing DNS lookup traffic in a network according to a preferred embodiment of the present invention. In step 500, router 222 receives a request for name resolution through a web browser, when the user requests to open a particular URL. For example, router 222 receives a DNS lookup request including a hostname of a web server identified in the URL. In step 502, router 222 checks cache database 400 to see if the cache database has the information needed to respond to the DNS lookup request by comparing the hostname received with the entries in cache database 400. In step 504, the router determines whether or not the cache database has an entry corresponding to the hostname.

If the cache database has an entry corresponding to the hostname of a web server, in step 506, router 222 provides the IP address assigned to the web server to the web browser. The web browser opens network connection to the web server using the IP address provided by the router 222 and downloads the document specified in the user's URL request. Next, in step 514, router 222 determines whether or not there are additional DNS lookup requests from the web browser. If there are no DNS lookup requests from the web browser, the process ends. Otherwise, the process repeats steps 502-514.

If the cache database does not include an entry corresponding to the hostname to be resolved, in step 508, router 222 forwards the DNS lookup request on to DNS server 224. In step 510, router 222 receives the information including the IP address corresponding to the hostname from the DNS server. In step 512, router 222 stores the information received from the DNS server in cache database 400 and forwards the IP address to the web browser. The web browser opens a network connection to the web server and downloads the document specified in the user's URL request. Next, in step 514, router 222 determines whether or not there are additional DNS lookup requests from the web browser. If there are no additional DNS lookup requests from the web browser, the process ends. Otherwise, the process repeats steps 502-514.

In the present invention, router 222 intercepts the network packets and provides the appropriate responses, rather than forwarding all DNS lookup request to a DNS server. Accordingly, the number of DNS lookup request being sent to a DNS server can be reduced. Specially, the number of redundant name resolution requests for the same host can be significantly reduced. Furthermore, network traffic can be reduced as well as the load on the DNS server.

The foregoing disclosure of the preferred embodiments of the present invention has been presented for purposes of illustration and description. It is not intended to be exhaustive or to limit the invention to the precise forms disclosed.

Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A system for reducing Domain Name System (DNS) lookup traffic in a computer data network comprising:
a router in communication with a client computer; and
a cache database associated with the router,
wherein the router receives a query including a first hostname from the client computer and compares the first hostname with information in the cache database and wherein the information includes at least one hostname and an IP address corresponding to the hostname.

2. The system of claim 1, wherein if the cache database includes an entry corresponding to the first hostname, the router sends an IP address corresponding to the first hostname to the client computer.

3. The system of claim 1, wherein if the cache database does not includes an entry corresponding to the first hostname, the router sends the query to a DNS server.

4. The system of claim 3, wherein the router receives an IP address corresponding to the first hostname from the DNS server and stores the IP address and the first hostname in the cache database.

5. The system of claim 1, wherein the information in the cache database includes a time stamp and the oldest information according to the time stamp is deleted as needed.

6. The system of claim 1, wherein the information in the cache database has a limited lifetime.

7. The system of claim 1, wherein the information in the cache database has a lifetime of about 30 seconds to 1 minute.

8. A system for reducing Domain Name System (DNS) lookup traffic in a computer data network comprising:
a cache database; and
a router including the cache database and in communication with a client computer,
wherein the cache database includes information including at least one hostname and an IP address corresponding to the hostname.

9. The system of claim 8, wherein the router receives a query including a first hostname from the client computer and compares the first hostname with the information in the cache database.

10. The system of claim 9, wherein if the cache database includes an entry corresponding to the first hostname, the router sends an IP address corresponding to the first hostname to the client computer.

11. The system of claim 9, wherein if the cache database does not include an entry corresponding to the first hostname, the router sends the query to a DNS server.

12. The system of claim 11, wherein the router receives an IP address corresponding to the first hostname from the DNS server and stores the IP address and the first hostname in the cache database.

13. A system for reducing Domain Name System (DNS) lookup traffic in a computer data network comprising:
a router in communication with a client computer; and
a cache database associated with the router,
wherein the router receives information including at least one hostname and an IP address corresponding to the hostname from a DNS server and stores the information in the cache database.

14. A method for reducing Domain Name System (DNS) lookup traffic in a computer data network in a system including a router and a cache database associated with the router, comprising the steps of:
receiving a query including a first hostname from a client computer in communication with the router; and
comparing the first hostname with information stored in the cache database, wherein the information stored in the cache database includes at least one hostname and an IP address corresponding to the hostname received from a DNS server.

15. The method of claim 14, wherein if the cache database includes an entry corresponding to the first hostname, the method further includes the step of sending an IP address corresponding to the first hostname to the client computer.

16. The method of claim 14, wherein the method further includes the steps of:
if the cache database does not include an entry corresponding to the first hostname,
sending the query to the DNS server;
receiving information including an IP address corresponding to the first hostname from the DNS server;
storing the information including an IP address corresponding to the first hostname in the cache database; and
sending the IP address corresponding to the first hostname to the client computer.

17. The method of claim 14, wherein the information stored in the cache database has a limited lifetime.

18. The method of claim 14, wherein the information stored in the cache database has a lifetime of about 30 seconds to 1 minute.

19. A method for reducing Domain Name System (DNS) lookup traffic in a computer data network, in a system including a router and a cache database associated with the router, comprising the steps of:
receiving a query including a first hostname from a client computer;
comparing the first hostname with information stored in the cache database;
if the cache database does not include an entry corresponding to the first hostname,
sending the query to a DNS server;
receiving information including the first hostname and an IP address corresponding to the first hostname from the DNS server;
storing the information in the cache database; and
sending the IP address to the client computer.

20. The method of claim 19, wherein the information stored in the cache database has a lifetime of about 30 seconds to 1 minute.

21. A method for reducing Domain Name System (DNS) lookup traffic in a computer data network including the steps of:
receiving a query including a hostname from a client computer in communication with a router; and
comparing the hostname with information in the cache database,
wherein the cache database is included in the router.

22. The method of claim 21, wherein if the cache database includes an entry corresponding to the hostname, the method further includes the step of sending an IP address corresponding to the hostname to the client computer.

23. The method of claim 21, wherein the method further includes the steps of:
if the cache database does not include an entry corresponding to the hostname, sending the query to a DNS server;
receiving information including an IP address corresponding to the hostname from the DNS server;
storing the information including an IP address corresponding to the hostname in the cache database; and
sending the IP address corresponding to the hostname to the client computer.

24. The method of claim 21, wherein the information stored in the cache database includes at least one hostname and an IP address corresponding to the hostname.

25. A method for reducing Domain Name System (DNS) lookup traffic in a computer data network in a system including a router and a cache database associated with the router, comprising the steps of:
receiving a query including a first hostname from a client computer in communication with the router;
comparing the first hostname with information stored in the cache database, wherein the information stored in the cache database includes at least one hostname and an IP address corresponding to the hostname received from a DNS server; and
if the cache database includes an entry corresponding to the first hostname, sending an IP address corresponding to the first hostname to the client computer.
